(19) United States
(12) Patent Application Publication
(10) Pub. No.: US 2010/0174589 A1
(43) Pub. Date: Jul. 8, 2010

(54) System and method for supporting allocation of reward points, and computer-readable storage medium for computer program

(75) Inventor: Takeshi Asai, Osaka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/659,528

(22) Filed: Mar. 11, 2010

Related U.S. Application Data
(63) Continuation of application No. PCT/JP2007/001103, filed on Oct. 11, 2007.

(51) Int. Cl. G06Q 30/00

(52) U.S. Cl. 705/14.3; 705/14.27

(57) ABSTRACT

A terminal for supporting allocation, to a customer, of reward points redeemable for an article or a service is provided. The terminal includes a soon-to-be-lost-point calculation portion that calculates, for each of reward programs in which the customer participates, an amount of soon-to-be-lost-reward points that is an amount of reward points to be lost during a predetermined period among the reward points, and a reward points information display process portion that displays, based on the result of calculation performed by the soon-to-be-lost-point calculation portion, a screen for indicating, among the reward programs, a reward program having the soon-to-be-lost-reward points whose amount is equal to or more than a predetermined value.

### CROSS-REFERENCE TO RELATED APPLICATIONS

This application is a continuing application, filed under 35 U.S.C. §111(a), of International Application PCT/JP2007/001103, filed on Oct. 11, 2007, the entire contents of which are incorporated herein by reference.

### FIELD

The embodiment discussed herein is related to a system and a method for supporting allocation, to customers, of reward points redeemable for articles and services.

### BACKGROUND

Businesses that offer a reward program to customers who purchase merchandise or receive services have recently increased. The reward program is designed to issue reward points to customers in accordance with the purchase amount, the frequency of purchase, or the like, and to allow the customers to redeem (exchange) reward points accumulated by the individual customers for articles, services, and the like. Such a reward program is sometimes called, for example, a “frequent flyer program”.

A business offers a unique reward program, while a plurality of businesses make a group to offer a common reward program. A credit card business, namely, a credit company also offers a reward program in which reward points are awarded (allocated) to a customer who has paid by a credit card issued by the credit company.

In some cases, reward points earned by a customer are centrally managed by a server or the like together with reward points earned by other customers. In other cases, reward points earned by a customer are stored and managed on a card of the customer.

In return for reward points accumulated by customers, businesses offer the customers a variety of articles such as accessories, commodities, foods, books, or clothing. The businesses also offer the customers articles other than those mentioned above, e.g., vouchers, gift certificates, or tickets. Further, services such as trips, meals, or accommodations are sometimes offered to the customers as items.

Thus, a customer can obtain a variety of articles and services in return for reward points accumulated by the customer. Further, participating in a plurality of reward programs enables a customer to select an article or a service from among the increased number of articles and services. More shops accept a plurality of reward programs.

In general, reward points have the expiration date for the reward points to be redeemed for an article or a service. Accumulated reward points are lost (invalid) after the expiration date.

A method for reducing such loss of accumulated reward points is disclosed in Japanese Laid-open Patent Publication No. 2007-058558. According to the method, a store terminal transmits, to a management server, point information including a point value calculated based on the price for a commodity or service that a user has purchased, user identification information, store identification information, and the expiration date. The management server has a control part for storing, in a point information storage part, the point information received from the store terminal. The control part, regarding the point information on each user stored in the point information storage part, calculates a remaining term before the expiration date for the point value included in the point information. If the calculated remaining term is the prescribed term or shorter, the control part transmits information on the point whose remaining term is the prescribe term or shorter to a mobile terminal identified based on the user identification information included in the point information.

A customer participating in a plurality of reward programs has to carry individual membership cards for the reward programs with him/her, which causes him/her inconvenience. To cope with this, the following methods are proposed in Japanese Laid-open Patent Publication Nos. 2002-041933 and 2003-030415.

According to the method disclosed in Japanese Laid-open Patent Publication No. 2002-041933, data tables corresponding to a plurality of point systems by a plurality of stores or a data table corresponding to a common point system is stored in one IC card, and shop identifiers are provided in individual records in the individual data tables to perform the addition or subtraction of points.

According to the method disclosed in Japanese Laid-open Patent Publication No. 2003-030415, a customer registers personal information with a user terminal and transmits the personal information to a management center server. The management center server generates a barcode ID and transmits the barcode ID to the user terminal. A barcode ID common to a plurality of membership systems is used for the same customer. The customer displays the barcode ID on a display for shopping at an affiliated store, and a store terminal reads the barcode ID with a barcode reader and transmits the barcode ID together with member data to the management center server. The management center server manages member data of a plurality of membership systems in a customer multidatabase. The customer can operate the user terminal to receive, from the management center server, the member data of the plurality of membership systems in which the customer participates, then to display a list of the member data.

Unfortunately, however, the conventional methods described in Japanese Laid-open Patent Publication Nos. 2007-058558, 2002-041933, and 2003-030415 are incapable of effectively reducing loss of reward points accumulated by a customer participating in a plurality of reward programs.

### SUMMARY

According to an aspect of the invention, a system for supporting allocation, to a customer, of reward points redeemable for an article or a service includes a reward point data obtaining portion that obtains reward point data indicating an amount of reward points of reward programs in which the customer participates, a calculator that calculates, for each of the reward programs, an amount of soon-to-be-lost-reward points that is an amount of reward points to be lost during a predetermined period among the reward points, based on the reward point data obtained by the reward point data obtaining portion, and a display that displays, based on a result of calculation performed by the calculator, a screen for indicating, among the reward programs, a reward program having the soon-to-be-lost-reward points whose amount is equal to or more than a predetermined value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the hardware configuration of a terminal;

FIG. 2 is a diagram illustrating an example of how a terminal is connected to other devices;

FIG. 3 is a diagram illustrating an example of the functional configuration of a terminal;

FIG. 4 is a diagram illustrating an example of a card attribute information table;

FIG. 5A through 5C are diagrams illustrating an example of point-loss management patterns;

FIG. 6 is a diagram illustrating an example of a card usage history table;

FIG. 7A is a diagram illustrating an example of a reward points exchange ratio table, and FIG. 7B is a diagram illustrating an example of a pattern priority table;

FIG. 8 is a flowchart illustrating an example of the flow of a card preparation process;

FIG. 9 is a diagram illustrating an example of the appearance of a setting device;

FIG. 10 is a flowchart illustrating an example of the flow of a soon-to-be-lost-point calculation process;

FIGS. 11A and 11B are diagrams illustrating an example of a reward points information screen;

FIGS. 12A and 12B are diagrams illustrating an example of a reward points information screen;

FIG. 13 is a flowchart illustrating an example of the overall processing flow of a terminal for allocating reward points; and

FIG. 14 is a flowchart illustrating an example of the overall processing flow of a terminal for allocating reward points.

### DESCRIPTION OF EMBODIMENT(S)

Preferred embodiments of the present invention will be explained with reference to accompanying drawings.

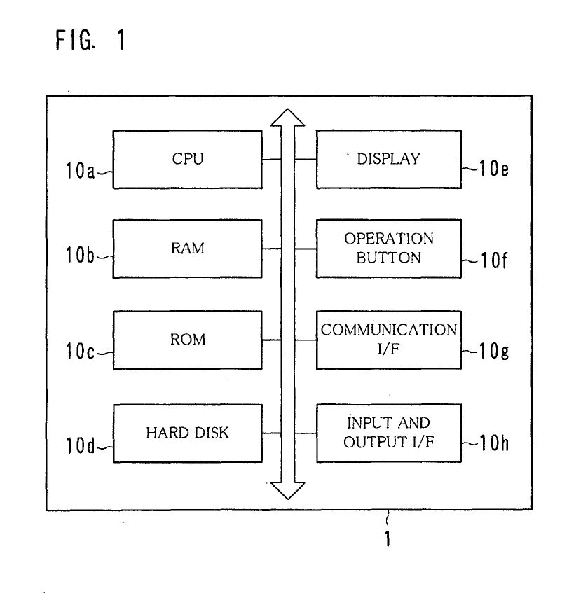

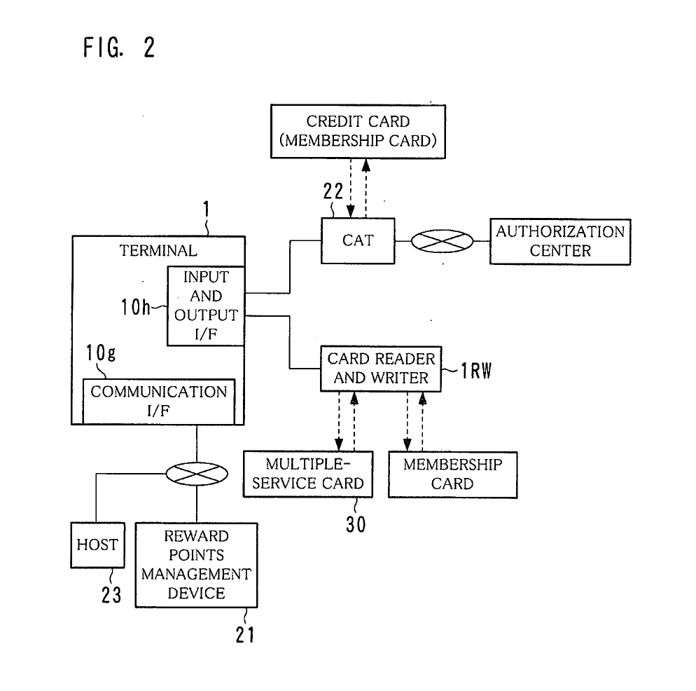

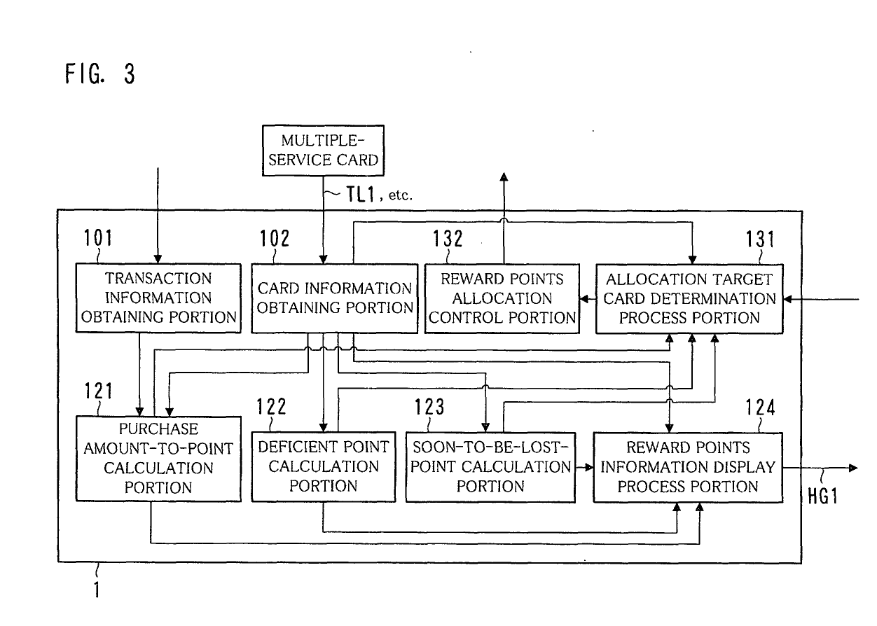

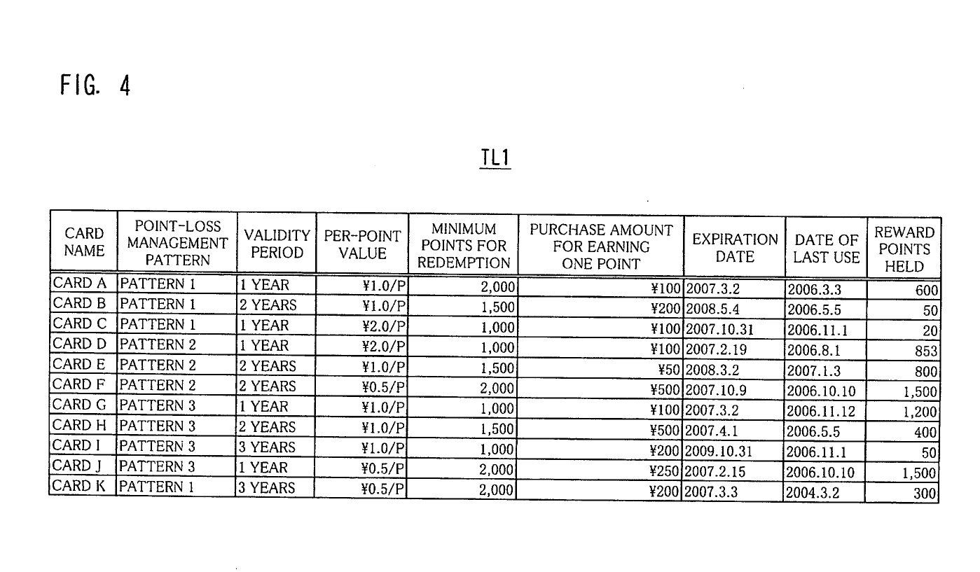

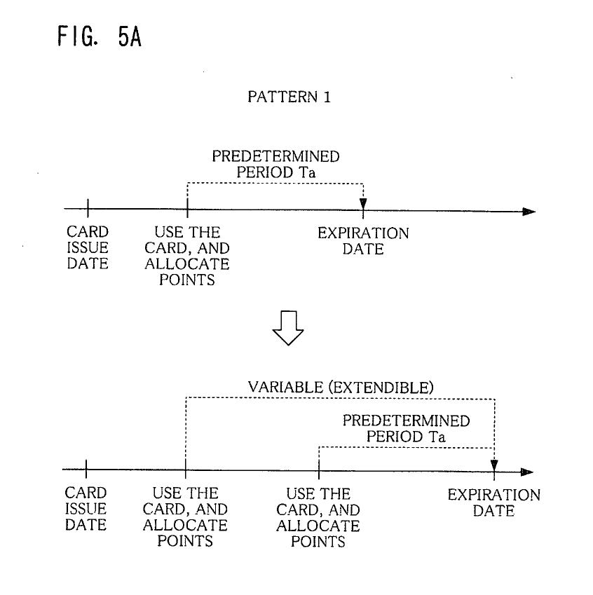

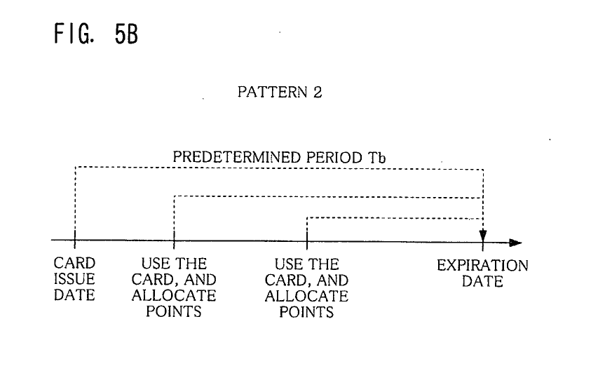

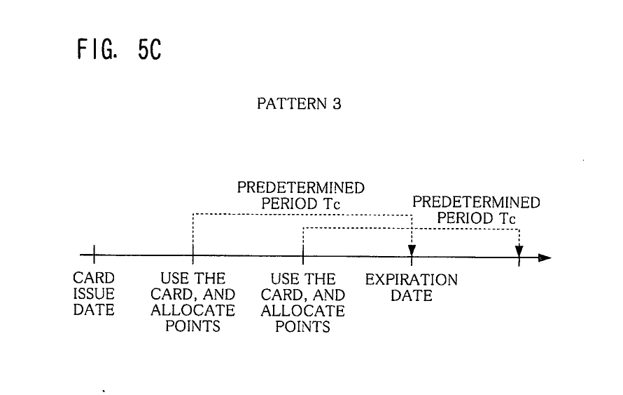

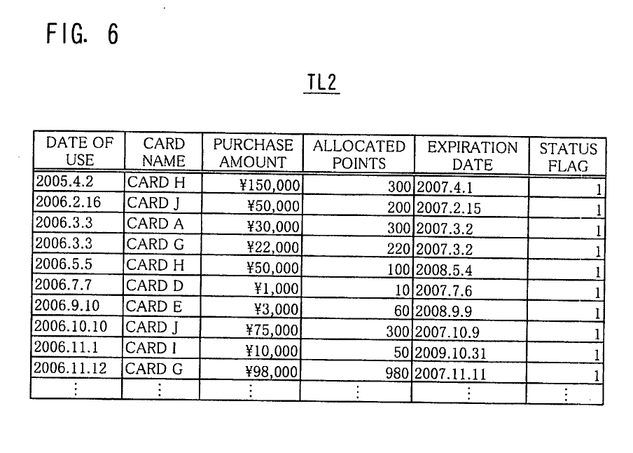

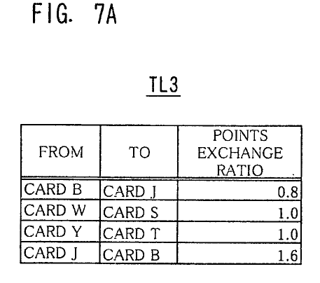

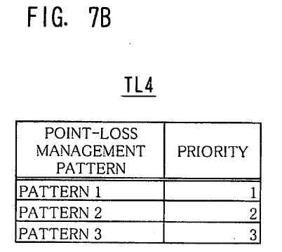

FIG. 1 is a diagram illustrating an example of the hardware configuration of a terminal 1; FIG. 2 is a diagram illustrating an example of how the terminal 1 is connected to other devices; FIG. 3 is a diagram illustrating an example of the functional configuration of the terminal 1; FIG. 4 is a diagram illustrating an example of a card attribute information table TL1; FIG. 5A through 5C are diagrams illustrating an example of point-loss management patterns; FIG. 6 is a diagram illustrating an example of a card usage history table TL2; FIG. 7A is a diagram illustrating an example of a reward points exchange ratio table TL3; and FIG. 7B is a diagram illustrating an example of a pattern priority table TL4.

The terminal 1 according to an embodiment of the invention is a point-of-sale (POS) terminal used in a shop that sells products or provides services. A POS cash register, a personal computer, or the like is used as the terminal 1.

Referring to FIG. 1, the terminal 1 is configured of a Central Processing Unit (CPU) 10a, a Random Access Memory (RAM) 10b, a Read Only Memory (ROM) 10c, a hard disk 10d, a display 10e, an operation button 10f, a communication interface 10g, an input and output interface 10h, and the like.

Referring to FIG. 2, the communication interface 10g is an interface to connect to a host 23 of a POS system or a reward points management device 21 for centrally managing reward points of a reward program, which is sometimes called a “frequent flyer program”. A Network Interface Card (NIC), a modem, or the like is used as the communication interface 10g.

Referring to FIG. 2, the input and output interface 10h is an interface to connect to, for example, a Credit Authorization Terminal (CAT) 22 for connecting to an authorization center of a credit card company or a credit company, or a card reader and writer 1RW. The input and output interface 10h is, for example, a USB interface, IEEE1394 interface, or RS-232C interface.

The operation button 10f is used for a clerk to enter the purchase amount of a product bought by a customer, a product code thereof, and the like. In the case where a barcode reader is connected to the terminal 1, the clerk may use the barcode reader instead of the operation button 10f to enter the purchase amount of the product, the product code thereof, and the like. As discussed later, the operation button 10f is also used to specify which reward program the customer desires to use to accumulate reward points. The display 10e serves to display, for example, a reward points information screen HG1 as described later.

Software for performing a process such as a sales management process or an inventory management process in cooperation with the host of the POS system is installed in the ROM 10c or the hard disk 10d as with conventional technologies.

The ROM 10c or the hard disk 10d stores programs and data for implementing, as illustrated in FIG. 2, functions of a transaction information obtaining portion 101, a card information obtaining portion 102, a purchase amount-to-point calculation portion 121, a deficient point calculation portion 122, a soon-to-be-lost-point calculation portion 123, a reward points information display process portion 124, an allocation target card determination process portion 131, a reward points allocation control portion 132, and so on. These programs and data are loaded into the RAM 10b as necessary, whereupon the programs are executed by the CPU 10a.

The following is a description of the terminal 1, taking an example of a terminal 1X that is used in a shop X that accepts membership cards issued by eleven businesses, i.e., a card A through a card J, and a card L, and is capable of awarding reward points corresponding to reward programs offered by the eleven businesses. An IC card is used as each of the membership cards.

A customer who has purchased a product at the shop X can be given (can earn) reward points of any one of the above-mentioned eleven reward programs depending on the purchase amount. At this time, the customer determines, as before, a reward program to be used to earn the reward points, and presents a membership card corresponding to the reward program to a clerk.

Thereafter, the customer is capable of obtaining an article or a service in return for accumulated reward points from a business from which the accumulated reward points are issued, i.e., a business from which the membership card corresponding to the accumulated reward points is issued.

If the customer participates in a multiple-service card program, the customer may present a card for the multiple-service card program to the clerk instead of the membership card described above. In such a case, the customer refers to the reward points information screen HG1 described later, and can easily select a membership card to be used, i.e., a reward program to be used to earn the reward points. Alternatively, the customer may cause the terminal 1 to automatically determine a membership card to be used.

The “multiple-service card program” is designed to use a single card into which functions of membership cards corresponding to a plurality of reward programs is integrated. A plurality of businesses from which membership cards are issued, i.e., issuers, may make a group to operate such a multiple-service card program. Alternatively, an Internet Service Provider (ISP) or the like may operate such a multiple-service card program.

Hereinafter, a card into which functions of membership cards issued by a plurality of issuers is integrated is referred to as a “multiple-service card 30”. The functions of the individual cards may be integrated into the multiple-service card 30. Further, the functions of a membership card that is not accepted by the shop X may be integrated into the multiple-service card 30. The multiple-service card 30 may be an IC card. The following is a description of an example in which the multiple-service card 30 into which the functions of the membership cards issued by the eleven businesses, or, in other words, the card A through the card K are integrated.

The multiple-service card 30 stores, thereon, the card attribute information table TL1, the card usage history table TL2, the reward points exchange ratio table TL3, and the pattern priority table TL4.

Referring to FIG. 4, the card attribute information table TL1 stores, therein, information on a variety of attributes of the individual membership cards in which an owner of the multiple-service card 30 enrolls. The field of “card name” indicates the name of a membership card, which means that the name of a reward program is implied therein.

Incidentally, the rule of the validity period of accumulated reward points, in other words, the rule of the timing at which accumulated reward points shall be invalid, generally differs according to reward programs. The rule is often defined, for example, in the following Pattern 1 through Pattern 3.

[Pattern 1] All accumulated reward points shall be valid only during a predetermined period Ta beginning on the date at which the membership card has been used most recently. The date is hereinafter referred to as the “date of last use”. All accumulated reward points shall be lost after the predetermined period Ta has elapsed. The date of last use of the membership card is updated when it is used. Thus, in the case of Pattern 1, the expiration date of accumulated reward points is variable as illustrated in FIG. 5A.
[Pattern 2] All accumulated reward points shall be valid only during a predetermined period Tb beginning on the date at which the membership card is issued. The date is hereinafter referred to as the “card issue date”. All accumulated reward points shall be lost after the predetermined period Tb has elapsed. The card issue date never changes. Thus, in the case of Pattern 2, all accumulated reward points have the same and constant expiration date as illustrated in FIG. 5B.
[Pattern 3] As illustrated in FIG. 5C, reward points shall be valid only during a predetermined period Tc beginning on the date at which the reward points are issued. The date is hereinafter referred to as the “reward points issue date”. Reward points shall be lost after the predetermined period Tc corresponding to the reward points has elapsed. Thus, in the case of Pattern 3, the expiration dates of reward points differ according to reward points even if the reward points are allocated to the identical member (customer).

Referring back to the description of the card attribute information table TL1 of FIG. 4, the field of “point-loss management pattern” indicates a rule pattern of loss of reward points accumulated in a membership card.

If the point-loss management pattern of the membership card is “Pattern 1”, the “validity period” field indicates the predetermined period Ta. If the point-loss management pattern of the membership card is “Pattern 2”, the “validity period” field indicates the predetermined period Tb. If the point-loss management pattern of the membership card is “Pattern 3”, the “validity period” field indicates the predetermined period Tc.

The field of “per-point value” indicates a value per reward point in Japanese yen. The field of “minimum points for redemption” indicates the amount of reward points required to be redeemed for an article or a service. The field of “purchase amount for earning one point” indicates how much money is to be spent on purchase in order for a customer to earn one reward point.

The field of “expiration date” specifies the expiration date of reward points accumulated in a membership card. Note, however, that, for a membership card corresponding to Pattern 3, the earliest expiration date of a plurality of expiration dates for reward points that are currently valid is indicated in the field. The field of “date of last use” specifies the date at which a membership card has been used most recently. The field of “reward points held” indicates the total amount of reward points accumulated in a membership card.

Referring to FIG. 6, the card usage history table TL2 stores, therein, information on individual histories of the use of the membership cards in which an owner of the multiple-service card 30 enrolls. Descriptions of the individual fields will be given later.

Referring to FIG. 7A, the reward points exchange ratio table TL3 indicates an exchange ratio used when reward points of a certain membership card are exchanged for reward points of a different membership card. Referring to FIG. 7B, the pattern priority table TL4 indicates the priority of point-loss management patterns of reward programs based on which an owner of the multiple-service card 30 desires to earn reward points.

Further, the multiple-service card 30 stores, thereon, for example, card IDs of the individual membership cards integrated thereinto, a name of an owner of the multiple-service card 30, an identification number of the multiple-service card 30, an automatic selection flag 5FG described later, reference item information 5SK, and a point-loss target period Ts.

[Preparation Process for Making a Multiple-Service Card 30 Available for Use]

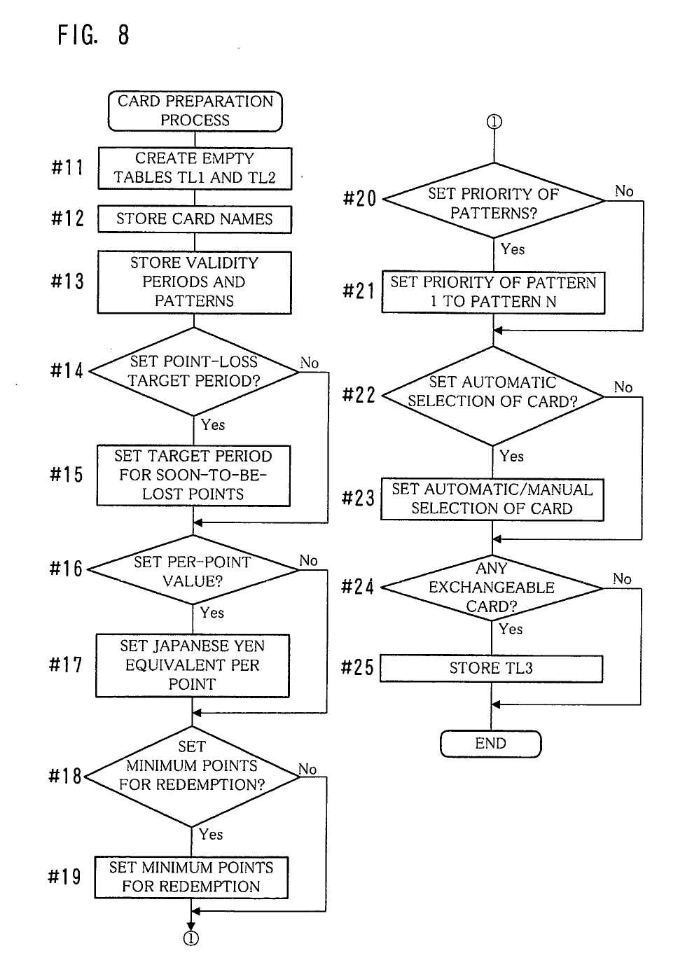

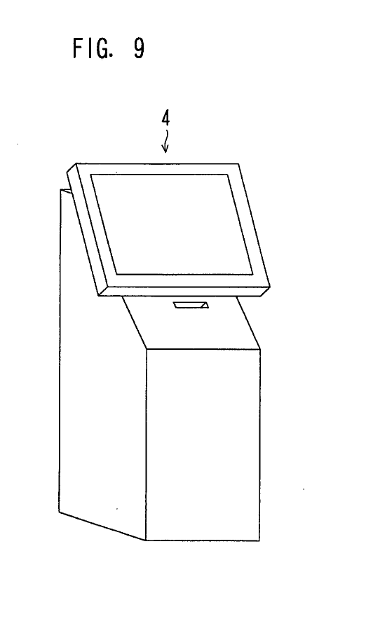

FIG. 8 is a flowchart illustrating an example of the flow of a card preparation process, and FIG. 9 is a diagram illustrating an example of the appearance of a setting device 4.

As described above, the multiple-service card 30 stores a variety of information thereon. Some of the information is to be stored on the multiple-service card 30 in advance of the use thereof. The following is a detailed description of a preparation process for making a multiple-service card 30 available for use.

A prospective member who wishes to use a multiple-service card 30 is required to enroll in the multiple-service card program. In order for the prospective member to enroll in the multiple-service card program, he/she conveys, to an operator of the multiple-service card program, information on his/her name, card IDs, and issuers of membership cards possessed by him/her, as to whether or not automatic selection of a membership card is to be performed, an item to be referred to for the automatic selection, as to how many months before the expiration date of accumulated reward points he/she desires to be informed that the reward points are to be expired, and the priority of point-loss management patterns of membership cards based on which he/she desires to earn reward points.

He/She may register to participate in the multiple-service card program by submitting a predetermined application paper to the operator of the multiple-service card program. Alternatively, he/she may register to participate in the multiple-service card program online by submitting a Web page application form that is prepared by the operator on a Web server on the Internet.

The operator enters the details of the information conveyed by the prospective member into a computer, e.g., a personal computer, connected to a card reader and writer. In the case where per-point values and minimum points for redemption of the individual membership cards are known, the operator also enters the per-point values and the minimum points for redemption into the computer. The operator inserts a new multiple-service card 30 into the card reader and writer, and enters a predetermined command into the computer. Responding to this, the computer performs the processing steps as illustrated in FIG. 8.

The computer creates a card attribute information table TL1 (see FIG. 4) and a card usage history table TL2 (see FIG. 6), both of which have no values therein, in the multiple-service card 30 inserted into the card reader and writer (#11). The computer then prepares records in the card attribute information table TL1 on a card-by-card basis.

The computer registers, in the individual records, the names of the corresponding membership cards entered by the operator, i.e., the card names (#12). The computer then registers, in the individual records, validity periods (Ta, Tb, or Tc) of accumulated reward points of the corresponding membership cards, and point-loss management patterns thereof (#13). Information on the validity period and the point-loss management pattern may be obtained by accessing a system of an issuer of each of the membership cards. Alternatively, the operator may enter such information. Yet alternatively, a database gathering such information therein may be prepared, and the information stored therein may be referred to.

In the case where information is entered as to how many months before the expiration date of accumulated reward points he/she desires to be informed that the reward points are to be expired (Yes in #14), the computer writes the corresponding period onto the multiple-service card 30 as the point-loss target period Ts (#15). In the case where a per-point value of a membership card is entered (Yes in #16), the computer registers the same into the record corresponding to the membership card (#17). In the case where minimum points for redemption of a membership card are entered (Yes in #18), the computer registers the same into the record corresponding to the membership card (#19).

As with the information on the validity period and the point-loss management pattern, the information on the point-loss target period Ts, the per-point value, and the minimum points for redemption may be obtained by accessing a system of an issuer of each of the membership cards. Alternatively, a database gathering such information therein may be prepared, and the information stored therein may be referred to.

In the case where information on the priority of point-loss management patterns of reward programs based on which he/she desires to earn reward points is entered (Yes in #20), the computer generates a pattern priority table TL4 (See FIG. 7B) based on the information entered, and stores the pattern priority table TL4 in the multiple-service card 30 (#21).

In the case where information as to whether or not automatic selection of a membership card is to be performed is entered, and further, an item to be referred to for the automatic selection is entered (Yes in #22), the computer generates an automatic selection flag 5FG indicating whether or not the automatic selection is to be performed, writes the automatic selection flag 5FG onto the multiple-service card 30, and writes the information on the item onto the multiple-service card 30 as the reference item information 5SK (#23).

If a membership card for a reward program whose reward points can be exchanged for reward points of a different reward program is included in the multiple-service card 30 as one of the membership cards integrated thereinto (Yes in #24), then the computer generates a reward points exchange ratio table TL3 (see FIG. 7A) indicating the exchange ratio, and writes the reward points exchange ratio table TL3 onto the multiple-service card 30 (#25). As with the information on the validity period and the like, the information on the exchange ratio may be obtained by accessing a system of an issuer of each of the membership cards. Alternatively, a database gathering such information therein may be prepared, and the information stored therein may be referred to.

The processing steps as described above make the multiple-service card 30 available for use. Thereafter, the operator hands the multiple-service card 30 to the prospective member.

Alternatively, each shop may install the setting device 4 as illustrated in FIG. 9. The setting device 4 has a size similar to that of a Cash Dispenser (CD) or an Automatic Teller Machine (ATM), and includes a touch panel and a card reader and writer. A program necessary for the processing described above with reference to FIG. 8 may be installed in the setting device 4 so that a prospective member operates the setting device 4 by himself/herself to perform setting of the multiple-service card 30. Yet alternatively, such a program may be installed in the terminal 1 so that a clerk operates the terminal 1 to perform setting of the multiple-service card 30.

[Process for Awarding Reward Points for a Case Where the Multiple-Service Card 30 is Used]

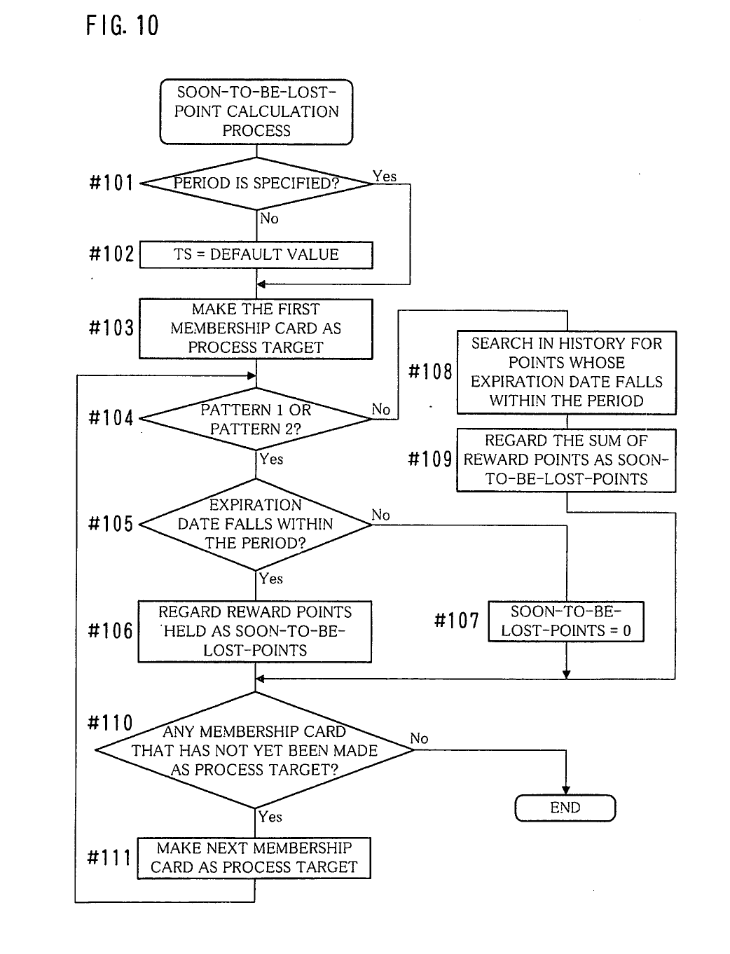

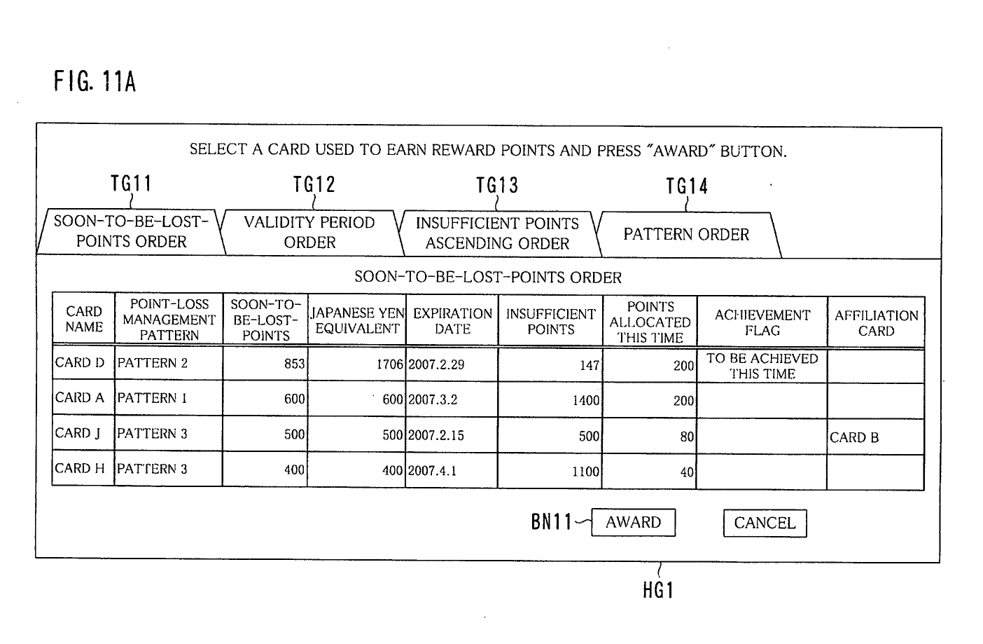

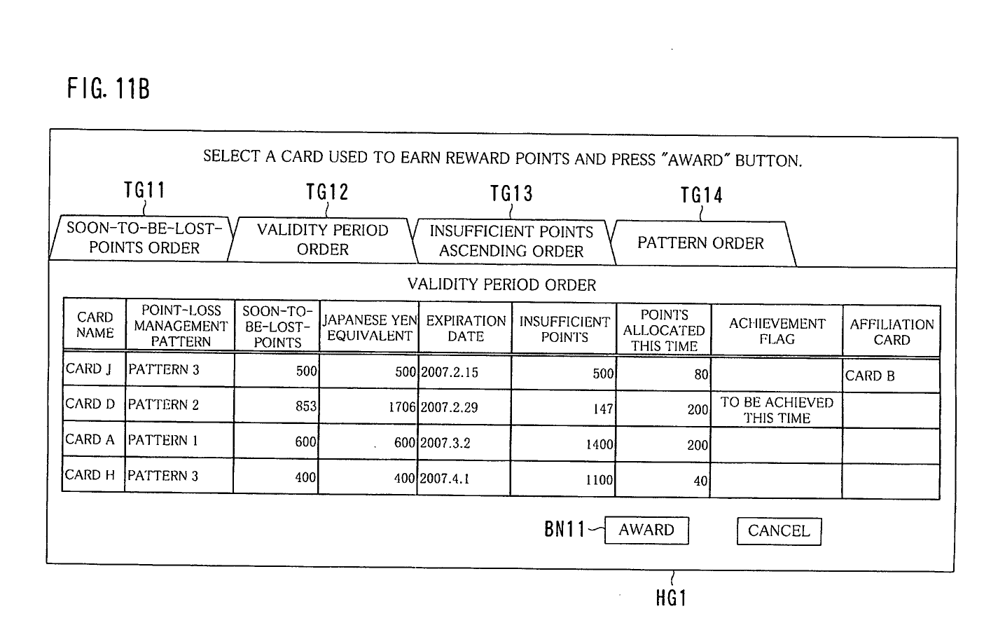

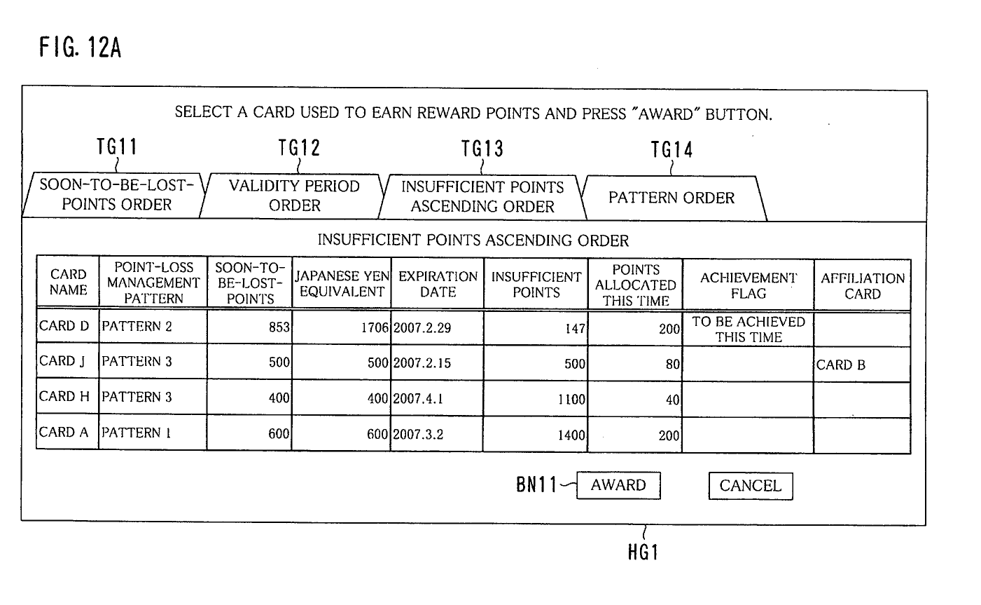

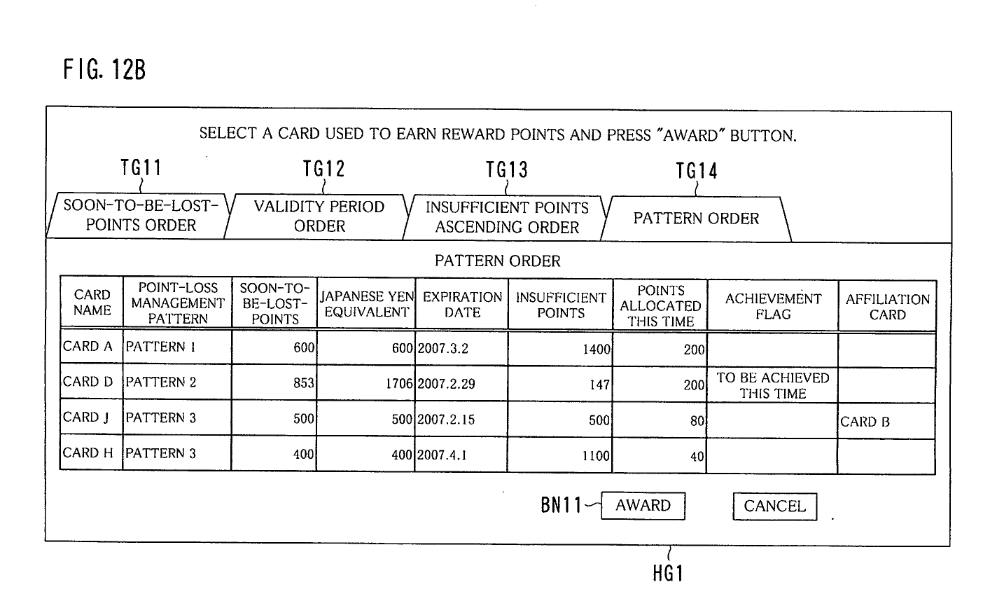

FIG. 10 is a flowchart illustrating an example of the flow of a soon-to-be-lost-point calculation process, and FIG. 11A through FIG. 12B are diagrams illustrating examples of the reward points information screen HG1.

The following is a detailed description of how the process is performed by the individual portions of the terminal 1X illustrated in FIG. 2 in order to award reward points.

When making a purchase at the shop X and paying for the purchase, a customer hands his/her multiple-service card 30 to a clerk. The clerk inserts the multiple-service card 30 into the card reader and writer 1RW, operates the operation button 10f, and enters the purchase amount, the product code, and the like. Responding to this, the transaction information obtaining portion 101 illustrated in FIG. 2 obtains the information entered.

The card information obtaining portion 102 controls the card reader and writer 1RW in such a manner that information stored on the multiple-service card 30 is read out from the multiple-service card 30 if required.

The purchase amount-to-point calculation portion 121, the deficient point calculation portion 122, and the soon-to-be-lost-point calculation portion 123 calculate the various values discussed below for a membership card corresponding to a reward program available in the shop X among the membership cards integrated into the multiple-service card 30.

In this embodiment, the card A through the card K are integrated into the multiple-service card 30 according to this embodiment as described earlier. The shop X, however, accepts the card A through the card J among the membership cards integrated into the multiple-service card 30. For this reason, the card A through the card J are targets of the processes performed by the purchase amount-to-point calculation portion 121, the deficient point calculation portion 122, and the soon-to-be-lost-point calculation portion 123.

The purchase amount-to-point calculation portion 121 uses the following equation (1) to calculate, for each membership card, the amount of reward points to be awarded depending on the purchase amount. Hereinafter, the amount of such reward points is referred to as a “point corresponding to purchase amount”.

Fpα=DK/FKα (1)

wherein “Fpa” represents the point corresponding to purchase amount of a card a (a=A, B, C, . . . , and J), “DK” represents the value of the purchase amount this time, “FKα” represents the value in the “purchase amount for earning one point” field of the card attribute information table TL1.

The deficient point calculation portion 122 uses the following equation (2) to calculate, for each membership card, the amount of reward points required to reach the minimum points for redemption, i.e., insufficient points to reach the minimum points for redemption. Hereinafter, the amount of such reward points is referred to as “insufficient points”.

Lpα=Spα−HPα (2)

wherein “Lpα” represents the insufficient points of the card α, “Spα” represents the value in the “minimum points for redemption” field of the card attribute information table TL1, and “HPα” represents the value in the “reward points held” field thereof.

The soon-to-be-lost-point calculation portion 123 calculates, for each membership card, the amount of accumulated reward points to be lost during a period from the present to the end of a predetermined amount of time (the point-loss target period Ts), in the manner as illustrated in FIG. 10. Hereinafter, the amount of such reward points is referred to as the “soon-to-be-lost-points”.

The point-loss target period Ts is the same as the point-loss target period Ts stored on the multiple-service card 30. If the point-loss target period Ts cannot be read out from the multiple-service card 30 (No in #101 of FIG. 10), then a default value set in the terminal 1 is regarded as the point-loss target period Ts (#102).

The first membership card is made as a process target (#103). At this time, a record, corresponding to the first membership card, in the card attribute information table TL1 read out from the multiple-service card 30 is made the process target. In the case where the point-loss management pattern of the target membership card is Pattern 1 or Pattern 2 (Yes in #104), the current reward points held are regarded as the soon-to-be-lost-points (#106), provided that the expiration date of accumulated reward points falls within the period from the present to the end of the point-loss target period Ts (Yes in #105). Unless the expiration date thereof falls therewithin (No in #105), the soon-to-be-lost-points are determined to be “zero point” (#107).

On the other hand, in the case where the point-loss management pattern of the target membership card is Pattern 3 (No in #104), search is carried out in the card usage history table TL2 read out from the multiple-service card 30 for accumulated reward points whose expiration dates fall within the period from the present to the end of the point-loss target period Ts (#108). Then, the sum of the accumulated reward points found by the search is determined as the soon-to-be-lost-points (#109).

If there is another membership card that has not yet been made as a process target, then the process of Step #104 through Step #109 is appropriately performed on such a membership card, as with the process on the first membership card.

Further, the soon-to-be-lost-point calculation portion 123 uses the following equation (3) to calculate, for each membership card, the value of the soon-to-be-lost-points. Hereinafter, the value is referred to as a “soon-to-be-lost-point value”.

SKα=TKα×FPα (3)

wherein “SKα” represents the soon-to-be-lost-point value of the card α, and “TKα” represents the value in the “per-point value” field of the card attribute information table TL1.

Referring back to FIG. 2, the reward points information display process portion 124 causes the display 10e to display the reward points information screen HG1 as illustrated in FIG. 11A, FIG. 11B, FIG. 12A, or FIG. 12B based on, for example, the calculation results of the purchase amount-to-point calculation portion 121, the deficient point calculation portion 122, and the soon-to-be-lost-point calculation portion 123, and the card attribute information table TL1 stored on the multiple-service card 30.

The reward points information screen HG1 illustrated in FIG. 11A displays a list of information on the individual membership cards in decreasing order of the soon-to-be-lost-points calculated by the soon-to-be-lost-point calculation portion 123. It is also possible that only membership cards having the soon-to-be-lost-points whose amount is equal to or more than a predetermined value are selected from among all the membership cards, and information on the membership cards selected is displayed as the list.

The list includes information other than the soon-to-be-lost-points. The “card name” and the “point-loss management pattern” of the list is based on the information included in the card attribute information table TL1. The “Japanese yen equivalent” is a soon-to-be-lost-point value calculated by the soon-to-be-lost-point calculation portion 123.

As for a membership card whose point-loss management pattern is Pattern 1 or Pattern 2, the “expiration date” is based on the information included in the card attribute information table TL1. As for a membership card whose point-loss management pattern is Pattern 3, the earliest date of the expiration dates for the currently-valid reward points of the membership card is used as the expiration date.

The “insufficient points” are deficient points calculated by the deficient point calculation portion 122. The “points allocated this time” are the points corresponding to purchase amount calculated by the purchase amount-to-point calculation portion 121, i.e., reward points to be allocated in accordance with the purchase amount this time.

The “achievement flag” indicates whether or not reward points are sufficiently accumulated to be redeemed for an article or a service. To be specific, if the value obtained by adding the value in the “reward points held” field to the value in the “points allocated this time” field of the card attribute information table TL1 is equal to or more than the minimum points for redemption, then the “achievement flag” specifies “TO BE ACHIEVED THIS TIME” which means that redeemable reward points are to be accumulated this time. If the value in the “reward points held” field of the card attribute information table TL1 is already equal to or more than the minimum points for redemption, then the “achievement flag” specifies “ALREADY ACHIEVED”.

The “affiliation card” field indicates a different membership card for which reward points accumulated on the subject membership card can be exchanged. This is based on information included in the reward points exchange ratio table TL3 (see FIG. 7A).

The clerk presents the reward points information screen HG1 to the customer who has made a purchase, and asks the customer which membership card is used to add the reward points earned this time.

Alternatively, the clerk may sort information on the individual membership cards based on items other than the soon-to-be-lost-points, and present the resultant indication made in the reward points information screen HG1 to the customer. If the clerk presses a validity period order tab TG12, then the reward points information display process portion 124 displays the reward points information screen HG1 as illustrated in FIG. 11B. The reward points information screen HG1 of FIG. 11B makes the indication in which information on the membership cards is sorted in chronological order of expiration dates of accumulated reward points. If the clerk presses an insufficient points ascending order tab TG13, then the reward points information display process portion 124 displays the reward points information screen HG1 as illustrated in FIG. 12A. The reward points information screen HG1 of FIG. 12A makes the indication in which information on the membership cards is sorted in ascending order of insufficient points. If the clerk presses a pattern order tab TG14, then the reward points information display process portion 124 displays the reward points information screen HG1 as illustrated in FIG. 12B. The reward points information screen HG1 of FIG. 12B makes the indication in which information on the membership cards is sorted in order of decreasing priority from the point-loss management pattern to which the highest priority is given. The priority is based on information included in the pattern priority table TL4 (see FIG. 7B).

The customer refers to the indications made in the reward points information screen HG1 presented by the clerk, determines a membership card to which the reward points earned this time are added, and conveys the determination to the clerk. Responding to this, the clerk selects the membership card determined by the customer from the list in the reward points information screen HG1, and presses an AWARD button BN11.

Referring back to FIG. 2, the allocation target card determination process portion 131 determines to which membership card reward points are to be awarded, in the following manner.

If the automatic selection flag 5FG read out from the multiple-service card 30 is “OFF”, then the allocation target card determination process portion 131 determines that reward points are to be allocated to the membership card selected on the reward points information screen HG1.

In contrast, if the automatic selection flag 5FG read out from the multiple-service card 30 is “ON”, then the allocation target card determination process portion 131 determines a membership card to which reward points are to be allocated based on the items indicated in the reference item information 5SK read out from the multiple-service card 30.

For example, if the reference item information 5SK specifies the “soon-to-be-lost-point”, then the allocation target card determination process portion 131 determines that reward points are to be allocated to a membership card having the largest amount of soon-to-be-lost-points. If the reference item information 5SK specifies the “expiration date”, then the allocation target card determination process portion 131 determines that reward points are to be allocated to a membership card having reward points whose expiration date is closest to the current date. If the reference item information 5SK specifies the “insufficient points”, then the allocation target card determination process portion 131 determines that reward points are to be allocated to a membership card having the least insufficient points, i.e., having accumulated reward points whose amount is closest to the minimum points for redemption.

In the case of Pattern 2, it is meaningless to add reward points newly to a membership card that has already been expired. To cope with this, the reward points information display process portion 124 displays the reward points information screen HG1 in such a manner that the list does not include information on the expired membership card corresponding to Pattern 2. Further, the allocation target card determination process portion 131 avoids automatic selection of the expired membership card corresponding to Pattern 2.

The reward points allocation control portion 132 controls the card reader and writer 1RW in such a manner that reward points are allocated to the membership card determined by the allocation target card determination process portion 131. The reward points allocation control portion 132 also controls the card reader and writer 1RW in such a manner that information on a record of the purchase this time and the allocation of reward points is written onto the multiple-service card 30. Note that how many reward points are to be allocated is already calculated by the purchase amount-to-point calculation portion 121.

Responding to this, the card reader and writer 1RW changes the record, corresponding to the membership card determined, included in the card attribute information table TL1 stored on the multiple-service card 30, in the following manner: The date in the “date of last use” field is updated with the current date; the amount of reward points to be allocated this time is added to the value in the “reward points held” field; and if the point-loss management pattern of the membership card is Pattern 1, the date of the “expiration date” field is updated with the date after the end of the period indicated in the “validity period” field from the current date.

The card reader and writer 1RW also adds, to the card usage history table TL2 (see FIG. 6), a record including the date at which the multiple-service card 30 has been used, i.e., the current date, the name of the membership card to which the reward points have been allocated, i.e., the card name, the amount of the purchase this time, i.e., the purchase amount, the amount of reward points allocated this time, i.e., the allocated point amount, the expiration date of the allocated reward points, and the status flag. The value of the status flag at this time is “1” which means that the allocated reward points are valid.

In the case where the reward points management device 21 manages reward points centrally, the reward points allocation control portion 132 preferably transmits, to the reward points management device 21, a command to award reward points, together with the information on the amount of reward points to be awarded this time, the card ID of the membership card to which the reward points are to be awarded, and the like. Responding to this, the reward points management device 21 performs a process for awarding reward points based on the information transmitted from the reward points allocation control portion 132.

The card reader and writer 1RW further changes the records included in the card attribute information table TL1 and the card usage history table TL2 appropriately in the following manner.

The card reader and writer 1RW searches in the card usage history table TL2 for a record corresponding to reward points that have been expired, and updates the value in the “status flag” field of the record with “2” which means that the reward points have been lost. The card reader and writer 1RW also updates the value in the “status flag” field of a record corresponding to reward points that have been redeemed for an article or a service with “3” which means that the reward points have been redeemed. As for a record corresponding to a membership card whose point-loss management pattern is Pattern 3 in the card attribute information table TL1, the card reader and writer 1RW updates the date in the “expiration date” field of the record with the same date as the expiration date of the oldest record having the value “1” in the “status flag” field in the card usage history table TL2.

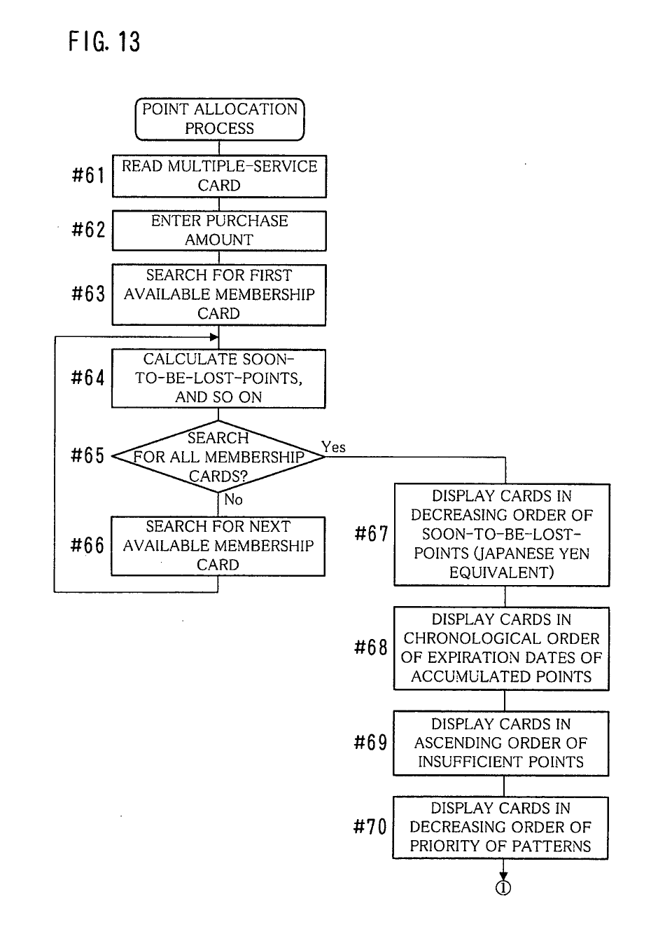

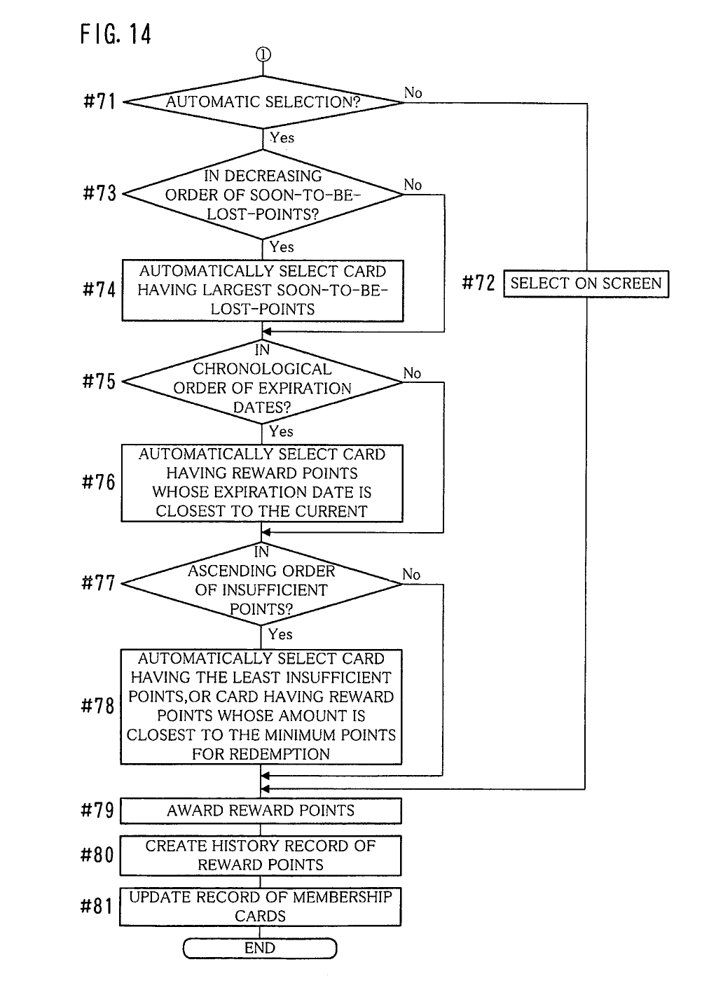

FIG. 13 and FIG. 14 are flowcharts illustrating an example of the overall processing flow of the terminal 1 for allocating reward points.

The following is a detailed description of steps of a process for awarding reward points, with reference to the flowcharts illustrated in FIGS. 13 and 14.

The terminal 1 causes the card reader and writer 1RW to read out information stored on the multiple-service card 30 (#61 of FIG. 13). The terminal 1 accepts entry of the purchase amount this time (#62).

As for a membership card accepted by the shop X among the membership cards integrated into the multiple-service card 30, the terminal 1 calculates the amount of reward points that are to be invalid during the point-loss target period Ts, that is, soon-to-be-lost points (#63 through #66). The terminal 1 also calculates points corresponding to purchase amount, and insufficient points of the membership card.

The terminal 1 displays the reward points information screen HG1 illustrated in FIG. 11A, FIG. 11B, FIG. 12A, or FIG. 12B appropriately based on the individual points calculated as described above, and the variety of information read out from the multiple-service card 30 (#67 through #70). At this time, the reward points information screen HG1 is displayed with the information on the individual membership cards sorted in accordance with a tab pressed by the clerk.

If the automatic selection flag 5FG is “OFF” (No in #71 of FIG. 14), then the terminal 1 awards reward points to the membership card selected from among the list in the reward points information screen HG1 (#72 and #79).

If the automatic selection flag 5FG is “ON” (Yes in #71), then the terminal 1 automatically determines a membership card to which reward points are to be awarded based on the reference item information 5SK. To be specific, if the reference item information 5SK specifies the “soon-to-be-lost-point” (Yes in #73), then the terminal 1 determines that reward points are to be awarded to a membership card having the largest amount of soon-to-be-lost-points (#74). If the reference item information 5SK specifies the “expiration date” (Yes in #75), then the terminal 1 determines that reward points are to be awarded to a membership card having reward points whose expiration date is closest to the current date (#76). If the reference item information 5SK specifies the “insufficient points” (Yes in #77), then the terminal 1 determines that reward points are to be allocated to a membership card having the least insufficient points, i.e., having accumulated reward points whose amount is closest to the minimum points for redemption (#78). It is also possible to determine, as the membership card to which reward points are to be allocated, a membership card having reward points whose amount is to reach the minimum points for redemption if reward points are awarded this time, or, alternatively, a membership card having reward points whose amount is already above the minimum points for redemption. Thereafter, the terminal 1 awards reward points to the membership card determined (#79).

The terminal 1 adds, to the card usage history table TL2, a record indicating the purchase this time and the details of the allocation of reward points (#80), and updates accordingly the record of the membership card to which the reward points have been awarded in the card attribute information table TL1 (#81).

In this embodiment, information on reward points accumulated by a customer is displayed for each reward program, or, in other words, each membership card. Further, such information is displayed in decreasing order of soon-to-be-lost-points, in decreasing order of values thereof, in chronological order of expiration dates of accumulated reward points, in ascending order of insufficient points, or in the order of point-loss management patterns desired by the customer. This embodiment thus makes it possible to prevent loss of reward points accumulated by a customer participating in a plurality of reward programs more effectively than is conventionally possible.

As discussed earlier with reference to FIG. 12A, information on the membership cards is displayed in ascending order of insufficient points. Instead, however, such information may be displayed in ascending order of purchase amount necessary to reach the minimum points for redemption.

In this embodiment, all the information on membership cards is obtained from the multiple-service card 30. Instead, a part or the whole of such information may be obtained from the reward points management device 21.

The minimum points for redemption may be arranged to be variable, for each customer, depending on an article or a service desired by the customer.

In the embodiments discussed above, the overall configuration of the terminal 1, the configurations of various portions thereof, the content to be processed, the processing order, the configuration of the tables, and the like may be altered as required in accordance with the subject matter of the present invention.

This invention is suitably used for a system handling a multiple-service card into which a plurality of membership cards are integrated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A system for supporting allocation, to a customer, of reward points redeemable for an article or a service, the system comprising:
a reward point data obtaining portion that obtains reward point data indicating an amount of reward points of reward programs in which the customer participates;
a calculator that calculates, for each of the reward programs, an amount of soon-to-be-lost-reward points that is an amount of reward points to be lost during a predetermined period among the reward points, based on the reward point data obtained by the reward point data obtaining portion; and
a display that displays, based on a result of calculation performed by the calculator, a screen for indicating, among the reward programs, a reward program having the soon-to-be-lost-reward points whose amount is equal to or more than a predetermined value.

2. The system according to claim 1, further comprising an information obtaining portion that obtains information from a multiple-service card that is a card into which membership cards issued, to the customer, by providers of the reward programs in which the customer participates are integrated,
wherein the calculator calculates the amount of soon-to-be-lost-reward points for each of the reward programs corresponding to the membership cards integrated into the multiple-service card.

3. The system according to claim 1, wherein the display displays, as the screen, a screen in which identification information of the reward programs is listed in descending order of a value of the soon-to-be-lost-reward points.

4. The system according to claim 1, wherein the display displays, as the screen, a screen in which identification information of the reward programs is listed in chronological order in which the soon-to-be-lost-reward points are lost.

5. The system according to claim 1, wherein the display displays, as the screen, a screen in which identification information of the reward programs is listed in descending order of an amount of accumulated reward points redeemable for an article or a service.

6. A method for supporting allocation, to a customer, of reward points redeemable for an article or a service, the method comprising:
causing a computer to perform:
a process of obtaining reward point data indicating an amount of reward points of reward programs in which the customer participates;
a calculation process of calculating, for each of the reward programs, an amount of soon-to-be-lost-reward points that is an amount of reward points to be lost during a predetermined period among the reward points, based on the reward point data thus obtained; and
a displaying process of displaying, based on a result of the calculation process, a screen for indicating, among the reward programs, a reward program having the soon-to-be-lost-reward points whose amount is equal to or more than a predetermined value.

7. A method for supporting allocation, to a customer, of reward points redeemable for an article or a service, the method comprising:
causing, when the customer pays for a purchase, a card reader and writer to read a multiple-service card that is provided to the customer in advance and is a card into which membership cards issued, to the customer, by providers of reward programs in which the customer participates are integrated, then to determine each of the membership cards integrated into the multiple-service card;
causing a computer to calculate, for each of the reward programs corresponding to the membership cards thus determined, an amount of soon-to-be-lost-reward points that is an amount of reward points to be lost during a predetermined period among the reward points accumulated by the customer; and
displaying, based on a result of calculation performed by the computer, a screen for indicating, among the reward programs, a reward program having the soon-to-be-lost-reward points whose amount is equal to or more than a predetermined value.

8. A computer-readable storage medium storing thereon a computer program used in a computer for supporting allocation, to a customer, of reward points redeemable for an article or a service, the computer program causing the computer to perform:
an obtaining process of obtaining reward point data indicating an amount of reward points of reward programs in which the customer participates;
a calculation process of calculating, for each of the reward programs, an amount of soon-to-be-lost-reward points that is an amount of reward points to be lost during a predetermined period among the reward points; and
a display process of displaying, based on a result of the calculation process, a screen for indicating, among the reward programs, a reward program having the soon-to-be-lost-reward points whose amount is equal to or more than a predetermined value.
